(19) United States
(12) Patent Application Publication
(10) Pub. No.: US 2006/0201935 A1
(43) Pub. Date: Sep. 14, 2006

(54) Manufacturing method, brazing apparatus and metal article

(75) Inventor: Hiroshi Nishikawa, Okazaki-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/365,894

(22) Filed: Feb. 27, 2006

(30) Foreign Application Priority Data
Mar. 9, 2005 (JP) 2005-066106

(51) Int. Cl. H05B 6/64

(52) U.S. Cl. 219/678; 148/525

(57) ABSTRACT

Microwaves in a frequency range of 300 MHz to 300 GHz are applied to an assembled heat exchanger received in a metal case of a brazing apparatus to generate heat from the heat exchanger and thereby to cause brazing in brazing portions of the heat exchanger with a brazing material. The brazing material or flux includes a heat generating material, such as silicon dioxide or silicon carbide, which generates heat upon application of the microwaves.

### CROSS REFERENCE TO RELATED APPLICATION

This application is based on and incorporates herein by reference Japanese Patent Application No. 2005-66106 filed on Mar. 9, 2005.

### BACKGROUND OF THE INVENTION

1. Field of the Invention

The present invention relates to a manufacturing method of a metal article, a brazing apparatus for brazing the metal article and the metal article formed thereby.

2. Description of Related Art

FIG. 8 is a schematic diagram for describing a prior art brazing method. In the prior art brazing, a work (an assembly) 100 is placed in a furnace 200, and an interior of the furnace 200 is heated to the high temperature by the heat generated from a heating device 600 (e.g., an electric heater, a gas heater) to increase the temperature of the work 100 to the brazing temperature to perform the brazing of the work 100. In the above furnace 200, a thermal insulation material is placed between an inner stainless component and an outer iron component of the furnace 200.

Furthermore, Japanese Unexamined Patent Publication Number H07-77612 (corresponding to EP0635737A1) recites brazing of an optical fiber to a silicon block through use of a resistive heating strip for heating and melting a brazing alloy and briefly recites use of microwave heating as an alternative to the resistive heating.

In the case of the above prior art brazing method described with reference to FIG. 8, the interior of the furnace is always kept to the high temperature, causing the heat radiation from the furnace main body. Particularly, even in the case where the work is not placed in the furnace, the interior of the furnace is always kept to the high temperature, so that the large amount of heat energy is required. Therefore, the heat energy, which is actually used to increase the temperature of the work, is less than one half of the total heat energy produced from the heating device.

### SUMMARY OF THE INVENTION

The present invention addresses the above disadvantages. Thus, it is an objective of the present invention to provide a manufacturing method, a brazing apparatus used therein and a metal article produced thereby, all of which enable an improved energy efficiency in production of the metal article.

To achieve the objective of the present invention, there may be provided a manufacturing method of a metal article. In the manufacturing method, at least one type of brazing material alone or both of the at least one type of brazing material and at least one type of flux may be provided to a plurality of metal members of an assembly before or after assembling of the plurality of metal members into the assembly. Microwaves in a frequency range of 300 MHz to 300 GHz may be applied to the assembly to generate heat from the assembly and thereby to cause brazing in at least one brazing portion of the assembly with the at least one type of brazing material for joining the plurality of metal members together.

To achieve the objective of the present invention, there may be provided a manufacturing method of a metal article. In the manufacturing method, at least one type of brazing material alone or both of the at least one type of brazing material and at least one type of flux may be provided to a plurality of metal members of an assembly before or after assembling of the plurality of metal members into the assembly. The assembly may be covered with a heat generating member, which generates heat upon application of microwaves thereto. Then, the microwaves in a frequency range of 300 MHz to 300 GHz may be applied to the heat generating member to generate the heat from the heat generating member and thereby to cause brazing in at least one brazing portion of the assembly with the at least one type of brazing material for joining the plurality of metal members together.

To achieve the objective of the present invention, there may be provided a brazing apparatus for brazing metal members of an assembly. The brazing apparatus may include a housing, a microwave generating means and a control means. The housing may receive the assembly and may have at least one inner-surface, which reflects microwaves. The microwave generating means may be for generating microwaves in a range of 300 MHz to 300 GHz and for supplying the microwaves into an interior of the housing. The control means may be for controlling an operation of the microwave generating means.

To achieve the objective of the present invention, there may be provided a metal article, which includes a plurality of metal members. The plurality of metal members may be brazed together by at least one type of brazing material alone or by both of the at least one type of brazing material and at least one type of flux. The at least one type of brazing material or the at least one type of flux includes a heat generating material, which is heated quickly upon application of microwaves thereto in a range of 300 MHz to 300 GHz.

### BRIEF DESCRIPTION OF THE DRAWINGS

The invention, together with additional objectives, features and advantages thereof, will be best understood from the following description, the appended claims and the accompanying drawings in which:

FIG. 1 is a plan view schematically showing a structure of a heat exchanger according to a first embodiment of the present invention;

FIG. 2 is a schematic diagram for describing a brazing method according to the first embodiment of the present invention;

FIG. 3 is a schematic diagram for describing a brazing method according to a second embodiment of the present invention;

FIG. 4 is a schematic diagram for describing a brazing method according to a third embodiment of the present invention;

FIG. 5 is a schematic diagram for describing a brazing method according to a fourth embodiment of the present invention;

FIG. 6 is a graph showing a relationship between a work temperature and time for presence of a heat generating member and absence of the heat generating member;

FIG. 7 is a schematic diagram for describing a brazing apparatus according to a fifth embodiment of the present invention; and

FIG. 8 is a schematic diagram for describing a prior art brazing method.

### DETAILED DESCRIPTION OF THE INVENTION

### FIRST EMBODIMENT

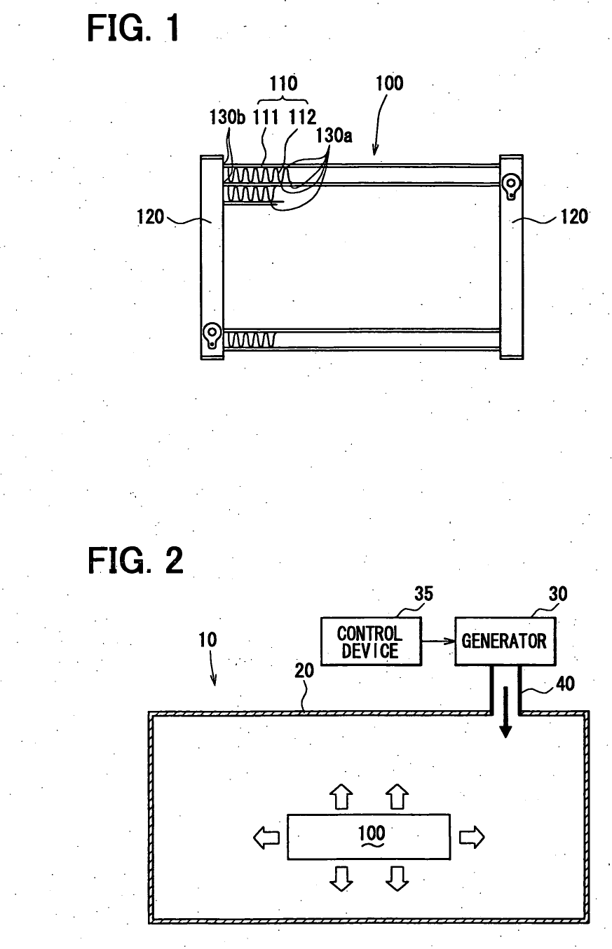

Now, a first embodiment of the present invention will be described with reference to the accompanying drawings. In the following description, a manufacturing method of a metal article will be also referred to as a brazing method of the metal article. FIG. 1 is a plan view showing a schematic structure of a heat exchanger 100 according to the first embodiment, and FIG. 2 is a schematic diagram showing the brazing method according to the first embodiment. In this particular instance, the heat exchanger 100, which serves as the metal article produced by the manufacturing method of the present embodiment, is embodied as a condenser (refrigerant radiator), which is arranged in a refrigeration cycle of a vehicle air conditioning system. However, it should be noted that the heat exchanger 100 may be alternatively embodied in any other applications, such as a heat exchanger of a home or office air conditioning system, a heat exchanger of a food refrigerator or freezer or the like.

With reference to FIG. 1, the heat exchanger 100 includes refrigerant tubes 111, heat exchange fins 112 and header tanks 120, which are all made of aluminum or an aluminum alloy. Specifically, the tubes 111, each of which has a generally flat cross section, are stacked one after another. The wavy fins (corrugated fins) 112, which are formed by roll forming, are interposed between each two of the tubes 111 to form a core 110.

The two header tanks 120, each of which has a cylindrical shape, are connected to ends, respectively, of each tube 111. The above metal members 111, 112, 120 are joined integrally by brazing. The heat exchanger 100 is arranged in a front part (backward of a front grille) in an engine compartment of the vehicle. The vapor refrigerant, which has the high temperature and the high pressure and flows through the tubes 111 (the core 110), is cooled by the external air and thereby is condensed into liquid refrigerant.

Now, the brazing method of the present embodiment used in the manufacturing of the heat exchanger 100 will be described. A brazing apparatus 10 includes a metal case (housing) 20, which has inner surfaces that are mirror finished. Microwaves are generated by a microwave generator (a microwave generating means) 30, which includes an oscillator, such as a gyrotron oscillator. The generated microwaves are guided into an interior of the case 20 through a waveguide 40.

Here, it should be noted that the microwaves, which are generated from the microwave generator 30, may be directly supplied into the case 20 without using the waveguide 40. A control device (a control means) 35 controls an operation of the microwave generator 30 to control, for example, a frequency, an intensity and an output time of the microwaves generated from the microwave generator 30.

An assembled intermediate product of the heat exchanger (corresponding to an assembly of the present invention and hereinafter being also referred to as a work) 100 is placed in the interior of the case 20. Thereafter, the microwaves, which are generated from the microwave generator 30, are applied to the assembly 100 to cause heat generation (i.e., self-heating) in the assembly 100 and thereby to cause integral brazing ( joining) of the metal members 111, 112, 120, which constitute the assembly 100.

In general, the microwaves are electromagnetic waves in a range of 300 MHz to 300 GHz (wavelength 1 m to 1 mm). Among the microwaves, waves in a range of about 30 GHz to 300 GHz (wavelength 15 mm to 1 mm) have a wavelength of few millimeters and are thereby referred to as millimeter waves.

When these microwaves are applied to the work, which is a dielectric body, the work itself generates the heat due to the electric field of the microwaves. This is the significant difference relative to the external heating, in which heat is generated externally of the work and is applied to the work. The work itself generates the heat rather than being heated through application of external heat from an external heat source to the work by way of heat radiation or heat conduction, so that it is possible to save the required energy, thereby achieving an improved energy efficiency in the production of the heat exchanger. Furthermore, the internal temperature distribution in the work is relatively good since the heating of the work does not rely on the heat conduction through the work. Therefore, it is possible to rapidly increase the temperature of the work.

The heat value of the work is proportional to the frequency of the microwaves. Thus, among the microwaves, the millimeter waves, which have the high frequencies, can achieve the higher heat generation efficiency. Furthermore, a uniform electric field distribution range (a uniform heat range achieved by the external heating) is increased when the frequency of the microwaves is increased. Thus, a relatively large volume of the work can be heated by the compact microwave generator 30.

Furthermore, a significant difference between the microwaves of 2.45 GHz and the microwaves of 28 GHz is that heating of metals is made possible by the microwaves of 28 GHz. Specifically, when the microwaves of 2.45 GHz are applied to the metal, an electric arc (electric spark) is generated. In contrast, when the microwaves of 28 GHz are applied to the metal, the metal can be uniformly heated without generating the electric arc.

In the brazing of the present embodiment, a 4000 series aluminum-silicon alloy brazing material or a nocolok flux of a type having potassium fluoride is used. Furthermore, a heat generating material, such as glass (silicon dioxide, i.e., SiO₂) or silicon carbide (SiC), which can be easily and quickly heated by the microwaves, is added to the above brazing material or the flux. Particularly, it is relatively easy to dissolve powder of silicon carbide (SiC) into solvent, which is then mixed into the flux.

Next, characteristics and advantages of the present embodiment will be described. First, the metal members 111, 112, 120 are assembled together to form the assembly 100. Here, the brazing material alone or together with the flux is provided to each brazing portion 130a, 130b of the assembly 100. Then, the assembly 100 is heated to the high temperature to join the metal members 111, 112, 120 together by the brazing at brazing portions 130a, 130b of the metal members 111, 112, 120 (FIG. 1). At this time, the microwaves in a range of 300 MHz to 300 GHz, desirably or optimally in a range of about 28 GHz to 300 GHz, are applied to the assembly 100 to cause generation of the high temperature heat in the assembly 100 to perform the brazing.

In this embodiment, the microwaves are used to cause the direct heat generation from the work to perform the brazing. It was previously believed that when the metal is heated by the microwaves, the electric spark is generated, so that the metal cannot be heated with such microwaves. However, when the frequency of the microwaves is increased to the certain range, the spark is not generated. The present invention is based on this knowledge. Thus, according to the present embodiment, the microwaves in this range are applied to the assembly 100 to cause the heat generation in the assembly 100 to perform the brazing. In the case of the direct heating of the metal article, the higher frequencies of the microwaves are desirable.

In this way, the work can be effectively heated regardless of the plate thickness (i.e., the wall thickness) of the work to uniformly heat the work. Furthermore, according to the present embodiment, the heat energy for heating the interior of the furnace is no longer required, so that the energy saving can be achieved. Unlike the prior art brazing performed in the prior art furnace, it is not required to wait until the temperature of the interior of the furnace reaches the predetermined temperature. Thus, it is not required to heat the furnace during the holidays or break time periods. In addition, it is no longer required to heat the interior of the furnace, so that the heat release from the furnace can be eliminated or minimized. As a result, it is possible to achieve the energy saving.

Furthermore, according to the present embodiment, the heat generating material, which can be easily and quickly heated upon application of the microwaves, is added to the brazing material or the flux. In this case, the relative dielectric constant of the metal members is made different from the relative dielectric constant of the brazing material or the flux, so that the brazing material or the flux can be easily and quickly heated first and can be easily melted. This eases the brazing of the metal members. The glass (SiO₂) or the silicon carbide (SiC) is used as the heat generating material. This material or the like can be effectively used as the heat generating material.

The brazing apparatus 10, which is used to perform the above brazing method, includes the case 20, the microwave generator 30 and the control device (the control means) 35. The case 20 receives the assembly 100 and may also receive or accommodate a thermal insulation member 50 and a heat generating member 60 (described below in the subsequent embodiments). Furthermore, inner surfaces of the case 20 are made to reflect the microwaves. The microwave generator 30 supplies the microwaves into the interior of the case 20. The control device 35 controls the operation of the microwave generator 30. With the above components, the brazing apparatus for brazing the metal members through use of the microwaves is implemented.

Furthermore, the gyrotron oscillator is used as the microwave generator 30. The gyrotron oscillator or the like can be effectively used as the microwave generator 30. The components of the heat exchanger 100 of the present embodiment are brazed together by the above brazing material alone or together with the flux. In the case of the fin and tube type heat exchanger shown in, for example, FIG. 1, the tanks, each of which has a relatively thick wall, cannot be easily heated by the radiation heat in the normal priori art furnace.

However, the heating by the microwaves causes heating and melting of the brazing material and the flux rather than the metal members 111, 112, 120. Therefore, there is provided the heat exchanger, upon which the brazing can be easily performed. The brazing material alone or together with the flux may be applied to the brazing portions 130b of the heat exchanger 100, which have a relatively high thermal capacity. Through the selection of the brazing material based on the wall thickness (the plate thickness), the brazing of the portions of the heat exchanger 100, which have the relatively high thermal capacity, can be selectively started first. Thus, it is possible to reduce the fraction defective.

### SECOND EMBODIMENT

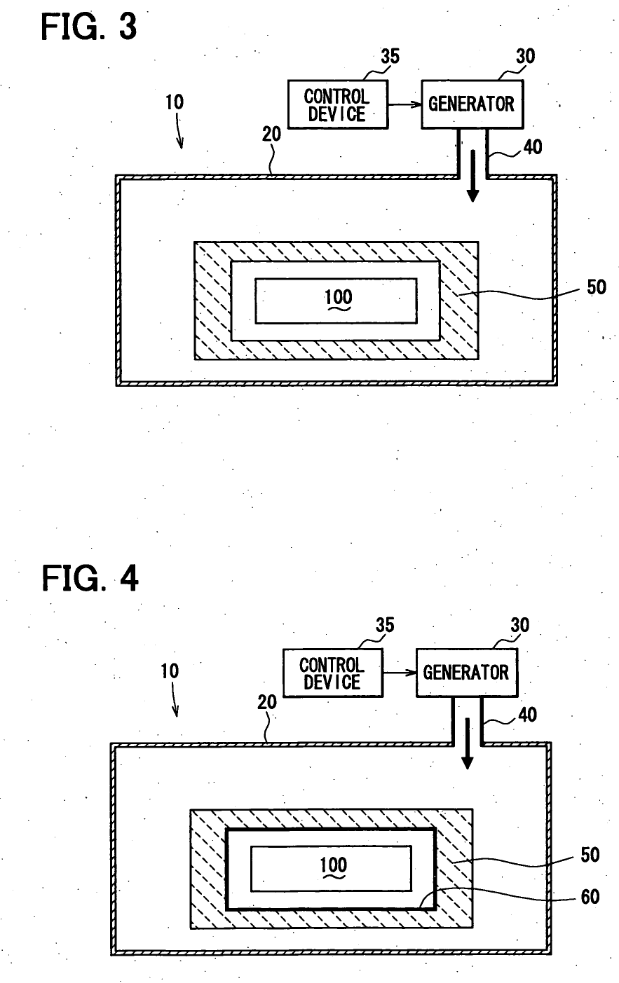

FIG. 3 is a schematic diagram for describing a brazing method according to a second embodiment of the present invention. The second embodiment differs from the first embodiment in the following points. That is, the assembly 100 is covered with the thermal insulation member 50, which hardly absorbs microwaves, i.e., does not substantially absorb the microwaves. With the above construction, the temperature increase of the assembly 100 can be promoted. The material of the thermal insulation member 50 may be ceramic fibers or alumina fibers, in which silica (SiO₂) is added to alumina (Al₂O₃). In the present embodiment, the thermal insulation member 50 may be in a form of a container. When the thermal insulation member 50 is in the form of the container, the assembly 100 may be placed in the container of the thermal insulation member 50 at the outside of the case 20 and then may be brought into the case 20. Alternatively, the thermal insulation member 50 may be formed as a part (e.g., a part of an inner wall) of the case 20.

### THIRD EMBODIMENT

FIG. 4 is a schematic diagram for describing a brazing method according to a third embodiment of the present invention. The third embodiment is different from the above embodiments in the following points. That is, according to the manufacturing method of the metal article of the third embodiment, the metal members 111, 112, 120 are assembled to form the assembly 100. Here, the brazing material alone or together with the flux is provided to the brazing portions 130a, 130b of the assembly 100. Then, the assembly 100 is heated to the high temperature to perform the brazing. Specifically, the assembly 100 is covered with the heat generating member 60, which generates the heat upon application of the microwaves thereto. Then, the microwaves in the range of 300 MHz to 300 GHz, desirably or optimally the microwaves of about 2.45 GHz, are applied to the heat generating member 60 to cause generation of the heat in the heat generating member 60. Therefore, the assembly 100, which is placed in the heat generating member 60, is heated to the high temperature by the heat generated from the heat generating member 60 to cause the brazing of the brazing portions 130a, 130b of the assembly 100.

In this way, the microwaves are applied to the heat generating member 60, which covers the assembly 100, to cause generation of the high temperature heat from the heat generating member 60, and the assembly 100 is heated by the radiation heat radiated from the heat generating member 60 to cause the brazing of the brazing portions 130a, 130b of the assembly 100. According to the third embodiment, the assembly 100 can be heated by the microwaves of low frequencies, such as the microwaves of about 2.45 GHz. Furthermore, it is only required to heat the heat generating member 60 and the assembly 100 received in the heat generating member 60. Thus, in comparison to the brazing performed in the prior art furnace, it is possible to save the energy. Although it is desirable to cover the entire assembly 100 with the heat generating member 60, the assembly 100 may be covered partially with the heat generating member 60.

Furthermore, the heat generating member 60 is covered with the thermal insulation member 50, which hardly absorbs the microwaves. In this way, the temperature increase of the assembly 100 can be promoted. Furthermore, the heat generating member 60 is added to the inner surface of the thermal insulation member 50. In this way, the heat generating member 60 for generating the heat and the thermal insulation member 50 for insulating the heat relative to the exterior of the thermal insulation member are constructed integrally, and thereby the required functions are optimally implemented. Specifically, for example, the silicon carbide (SiC) may be dissolved into the solvent and may be applied to the heat generating member 60.

Here, the silicon carbide (SiC) is used as the material of the heat generating member 60. The silicon carbide (SiC) or the like may be used to form the heat generating member 60. Furthermore, a magnetron oscillator is used as the microwave generator 30. The magnetron oscillator is typically used in microwave ovens and is relatively inexpensive. Furthermore, the magnetron oscillator can generate the microwaves of about 2.45 GHz, which are suitable for generating the heat from the silicon carbide (SiC). The magnetron oscillator or the like can be effectively used as the microwave generator 30. Also, the gyrotron oscillator may be used in place of the magnetron oscillator, if desired. Furthermore, the assembly 100 may be covered with the thermal insulation member 50 and the heat generating member 60 at the outside of the case 20 and then may be brought into the case 20. In such a case, the thermal insulation member 50 and the heat generating member 60 may be formed in a form of a container. Alternatively, the thermal insulation member 50 and the heat generating member 60 may be formed as a part (e.g., a part of an inner wall) of the case 20.

### FOURTH EMBODIMENT

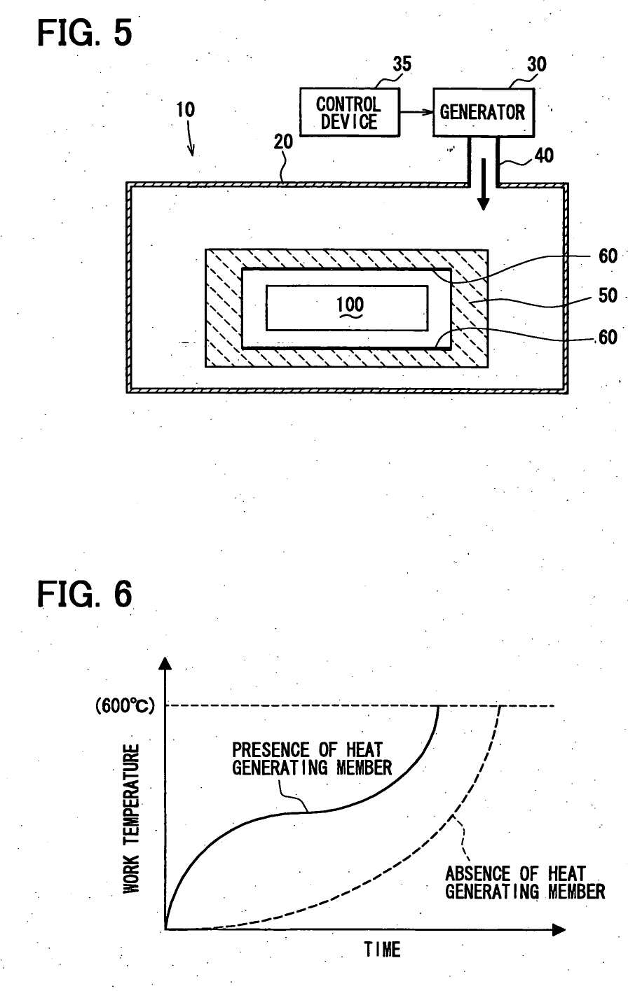

FIG. 5 is a schematic diagram for describing a brazing method according to a fourth embodiment of the present invention. The fourth embodiment is different from the above embodiments in the following points. That is, according to the manufacturing method of the metal article of the fourth embodiment, the metal members 111, 112, 120 are assembled to form the assembly 100. Here, the brazing material alone or together with the flux is provided to the brazing portions 130a, 130b of the assembly 100. Then, one or more of the surfaces of or one or more portions of the assembly 100 is covered with the heat generating member 60, which generates the heat upon application of the microwaves. Thereafter, the microwaves in the range of 300 MHz to 300 GHz, desirably or optimally the microwaves of about 2.45 GHz to about 28 GHz, are applied to both of the , assembly 100 and the heat generating member 60 to cause generation of the heat in the assembly 100 and in the heat generating member 60 and thereby to perform the soldering.

The microwaves are applied to both of the heat generating member 60 and the assembly 100 to generate the heat therefrom, so that there is implemented hybrid brazing. In this way, the temperature increase of the assembly 100 can be promoted. FIG. 6 is a graph showing a relationship between a work temperature (a temperature of the work) and time for a case of presence of the heat generating member 60 and a case of absence of the heat generating member 60.

In the present embodiment, the microwaves of the frequency (e.g., about 28 GHz) suitable for heating the assembly 100 (serving as the metal article) and the microwaves of the frequency (e.g., about 2.45 GHz) suitable for heating the heat generating member 60 may be simultaneously applied. Furthermore, the heat generating member 60 may not cover the entire surface of the assembly 100. In other words, it is only required to cover any surface or portion of the assembly 100 with the heat generating member 60. Furthermore, the assembly 100 may be covered with the thermal insulation member 50 and the heat generating member 60 at the outside of the case 20 and then may be brought into the case 20. In such a case, the thermal insulation member 50 and the heat generating member 60 may be formed in a form of a container. Alternatively, the thermal insulation member 50 and the heat generating member 60 may be formed as a part (e.g., a part of an inner wall) of the case 20.

### FIFTH EMBODIMENT

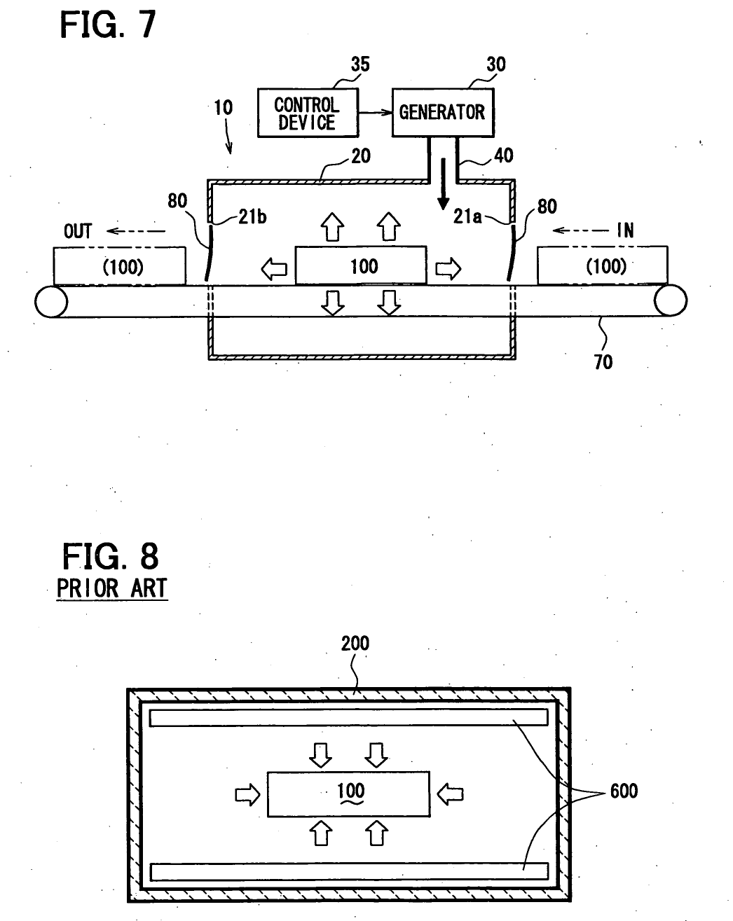

FIG. 7 is a schematic diagram for describing a brazing apparatus 10 according to a fifth embodiment of the present invention. The fifth embodiment differs from the above embodiments in the following points. That is, in the fifth embodiment, at least the assembly 100 is transferred into the interior of the case 20 trough an inlet opening 21a of the case 20 and receives the microwaves under a predetermined condition to cause the brazing of the brazing portions 130a, 130b of the assembly 100. Then, the assembly 100 after the brazing is transferred out of the case 20 through an output opening 21b of the case 20.

Specifically, in FIG. 7, numeral 70 indicates a metal conveyor, and numeral 80 indicates a metal curtain, which limits leakage of microwaves through the corresponding opening 21a, 21b of the case 20. With this construction, the brazing of the assembly 100 can be continuously performed one after another, so that the brazing apparatus, which achieves the high productivity, can be implemented.

The present invention is not limited to the above embodiments, and the above embodiments may be modified as follows.

In each of the above embodiments, the brazing method of the present invention is applied in the brazing of the heat exchanger. However, the present invention is not limited to the above embodiments. Specifically, the present invention can be applied to brazing of another type of metal article or any other component or product (e.g., a piping component, an ejector), which involves assembling of metal components and brazing of the resultant assembly by increasing the temperature of the assembly.

In the above embodiments, the silicon dioxide (SiO₂) or the silicon carbide (SiC) is added to the above brazing material or the flux as the heat generating material. Alternatively, any other suitable silicon compound or any other suitable material may be added to the brazing material or the flux as the heat generating material.

Also, in the above embodiments, the silicon carbide (SiC) is added in the heat generating member 60. Alternatively, any other suitable silicon compound or any other suitable material may be added in the heat generating member.

Furthermore, in each of the above embodiments, it is possible to use only one type of brazing material. Alternatively, it is also possible to use two or more different types of brazing materials, which include the heat generating material and have different relative dielectric constants (e.g., a higher relative dielectric constant and a lower relative dielectric constant). For example, the relative dielectric constants can be changed between the two different types of brazing materials by appropriately selecting the types of the heat generating materials. Here, it should be noted that the brazing material, which has the higher relative dielectric constant, can generate a greater amount of heat upon application of the microwaves in comparison to the brazing material, which has the lower relative dielectric constant. Because of the above characteristics, the brazing material, which has the higher relative dielectric constant, may be used to solder the tanks 120, which have the thicker walls, to the refrigerant tubes 111 at the brazing portions 130b. In contrast, the brazing material, which has the lower relative dielectric constant, may be used to solder the heat exchange fins 112, which have thinner walls, to the refrigerant tubes 111 at the brazing portions 130a. The above discussion with respect. to the one type of brazing material or the two or more different types of brazing materials is also applicable to the flux. Thus, it is possible to use two or more different types of fluxes, which include the heat generating material and have different relative dielectric constants. These two or more types of fluxes may be used in a manner similar to the two types of brazing materials.

Also, with respect to each of the above embodiments, it should be noted that the brazing material and/or the flux may be provided to the metal members 111, 112, 120 before or after the assembling of the metal members 111, 112, 120 into the assembly 100. Also, the brazing material and the flux may be provided to the metal members 111, 112, 120 separately one after anther or may be simultaneously provided to the metal members 111, 112, 120.

In the fifth embodiment, the thermal insulation member and the heat generating member are not provided in the brazing apparatus 10. Also, the assembly 100 is not covered with the thermal insulation member or the heat generating member at the time of transferring the assembly 100 into the brazing apparatus 10. However, the thermal insulation member 50 and/or the heat generating member 60 may be formed in a form of a container to receive the assembly 100 like those of the second to fourth embodiments. Then, this container, which receives the assembly 100, may be transferred into the brazing apparatus 10 by the metal conveyor 70. Alternatively, the thermal insulation member 50 and/or the heat generating member 60 may be provided as a part (a part of an inner wall) of the case or housing 20, if desired.

Additional advantages and modifications will readily occur to those skilled in the art. The invention in its broader terms is therefore not limited to the specific details, representative apparatus, and illustrative examples shown and described.

What is claimed is:

1. A manufacturing method comprising:
providing at least one type of brazing material alone or both of the at least one type of brazing material and at least one type of flux to a plurality of metal members of an assembly before or after assembling of the plurality of metal members into the assembly; and
applying microwaves in a frequency range of 300 MHz to 300 GHz to the assembly to generate heat from the assembly and thereby to cause brazing in at least one brazing portion of the assembly with the at least one type of brazing material for joining the plurality of metal members together.

2. The manufacturing method according to claim 1, wherein the microwaves are in a range of about 28 GHz to 300 GHz.

3. The manufacturing method according to claim 1, further comprising covering the assembly with a thermal insulation member, which does not substantially absorb the microwaves, before the applying of the microwaves.

4. The manufacturing method according to claim 3, wherein a material of the thermal insulation member includes at least one of ceramic fibers and alumina fibers.

5. The manufacturing method according to claim 1, wherein a heat generating material, which is heated quickly upon application of the microwaves thereto, is added to the at least one type of brazing material or the at least one type of flux.

6. The manufacturing method according to claim 5, wherein the heat generating material includes at least one of silicon dioxide and silicon carbide.

7. The manufacturing method according to claim 1, wherein the at least one type of brazing material includes:
a first type of brazing material that has a first relative dielectric constant; and
a second type of brazing material that has a second relative dielectric constant, which is different from the first relative dielectric constant.

8. The manufacturing method according to claim 1, wherein the at least one type of flux includes:
a first type of flux that has a first relative dielectric constant; and
a second type of flux that has a second relative dielectric constant, which is different from the first relative dielectric constant.

9. A manufacturing method comprising:
providing at least one type of brazing material alone or both of the at least one type of brazing material and at least one type of flux to a plurality of metal members of an assembly before or after assembling of the plurality of metal members into the assembly;
covering the assembly with a heat generating member, which generates heat upon application of microwaves thereto; and
applying the microwaves in a frequency range of 300 MHz to 300 GHz to the heat generating member to generate the heat from the heat generating member and thereby to cause brazing in at least one brazing portion of the assembly with the at least one type of brazing material for joining the plurality of metal members together.

10. The manufacturing method according to claim 9, wherein the microwaves are of about 2.45 GHz.

11. The manufacturing method according to claim 9, wherein the microwaves are in a range of about 2.45 GHz to about 28 GHz.

12. The manufacturing method according to claim 9, wherein the covering of the assembly with the heat generating member includes covering one or more surfaces or one or more portions of the assembly without entirely covering the assembly with the heat generating member.

13. The manufacturing method according to claim 9, wherein the applying of the microwaves includes applying of the microwaves to both of the assembly and the heat generating member to generate heat from both of the assembly and the heat generating member.

14. The manufacturing method according to claim 9, further comprising covering the assembly with a thermal insulation member, which does not substantially absorb the microwaves, before the applying of the microwaves.

15. The manufacturing method according to claim 9, wherein the heat generating member is covered with a thermal insulation member, which does not substantially absorb the microwaves, before the applying of the microwaves.

16. The manufacturing method according to claim 15, wherein the heat generating member is added to an inner surface of the thermal insulation member, so that the heat generating member is placed between the thermal insulation member and the assembly.

17. The manufacturing method according to claim 14, wherein a material of the thermal insulation member includes at least one of ceramic fibers and alumina fibers.

18. The manufacturing method according to claim 9, wherein a material of the heat generating member includes silicon carbide.

19. The manufacturing method according to claim 9, wherein a heat generating material, which is heated quickly upon application of the microwaves thereto, is added to the at least one type of brazing material or the at least one type of flux.

20. The manufacturing method according to claim 19, wherein the heat generating material includes at least one of silicon dioxide and silicon carbide.

21. The manufacturing method according to claim 9, wherein the at least one type of brazing material includes:
a first type of brazing material that has a first relative dielectric constant; and
a second type of brazing material that has a second relative dielectric constant, which is different from the first relative dielectric constant.

22. The manufacturing method according to claim 9, wherein the at least one type of flux includes:
a first type of flux that has a first relative dielectric constant; and
a second type of flux that has a second relative dielectric constant, which is different from the first relative dielectric constant.

23. A brazing apparatus for brazing metal members of an assembly, comprising:
a housing, which receives the assembly and has at least one inner surface, which reflects microwaves;
a microwave generating means for generating microwaves in a range of 300 MHz to 300 GHz and for supplying the microwaves into an interior of the housing; and
a control means for controlling an operation of the microwave generating means.

24. The brazing apparatus according to claim 23, wherein the microwave generating means generates the microwaves in a range of about 28 GHz to 300 GHz.

25. The brazing apparatus according to claim 23, wherein the microwave generating means generates the microwaves in a range of about 2.45 GHz to about 28 GHz.

26. The brazing apparatus according to claim 25, wherein the microwave generating means generates the microwaves of about 2.45 GHz.

27. The brazing apparatus according to claim 25, wherein a heat generating member, which generates heat upon application of the microwaves thereto, is arranged in the housing in such a manner that the heat generating member is interposed between the microwave generating means and the assembly.

28. The brazing apparatus according to claim 26, wherein a material of the heat generating member includes silicon carbide.

29. The brazing apparatus according to claim 23, wherein a thermal insulation member, which does not substantially absorb the microwaves, is arranged in the housing in such a manner that the thermal insulation member is interposed between the microwave generating means and the assembly.

30. The brazing apparatus according to claim 29, wherein a material of the thermal insulation member includes at least one of ceramic fibers and alumina fibers.

31. The brazing apparatus according to claim 23, wherein the microwave generating means includes one of a magnetron oscillator and a gyrotron oscillator.

32. The brazing apparatus according to claim 23, wherein the housing includes:
an inlet opening, thorough which the assembly is transferred into the interior of the housing; and
an outlet opening, through which the assembly is transferred out of the housing.

33. A metal article comprising a plurality of metal members, wherein:
the plurality of metal members is brazed together by at least one type of brazing material alone or by both of the at least one type of brazing material and at least one type of flux; and
the at least one type of brazing material or the at least one type of flux includes a heat generating material, which is heated quickly upon application of microwaves thereto in a range of 300 MHz to 300 GHz.

34. The metal article according to claim 33, wherein the heat generating material includes at least one of silicon dioxide and silicon carbide.

35. The meal article according to claim 33, wherein the plurality of metal members is brazed together in at least one brazing portion, wherein each of the at least one brazing portion has a relatively high thermal capacity in the metal article.

36. The metal article according to claim 33, wherein the at least one type of brazing material includes:
a first type of brazing material that has a first relative dielectric constant; and
a second type of brazing material that has a second relative dielectric constant, which is different from the first relative dielectric constant.

37. The metal article according to claim 33, wherein the at least one type of flux includes:
a first type of flux that has a first relative dielectric constant; and
a second type of flux that has a second relative dielectric constant, which is different from the first relative dielectric constant.

38. The metal article according to claim 33, wherein the metal article is a heat exchanger.
